(19) United States
(12) Patent Application Publication
(10) Pub. No.: US 2026/0225047 A1
(43) Pub. Date: Aug. 6, 2026

(54) GENERATION OF NANO AND PICO BUBBLES WITH VARIABLE GAS/LIQUID RATIOS FOR EFFECTIVE INTERFACE TRANSPORT AND PARTICLE SEPARATION

(71) Applicant: PRD Tech, Inc., Cincinnati, OH (US)

(72) Inventor: Rakesh Govind, Cincinnati, OH (US)

(21) Appl. No.: 19/530,782

(22) Filed: Feb. 5, 2026

Related U.S. Application Data
(60) Provisional application No. 63/754,744, filed on Feb. 6, 2025.

(51) Int. Cl. B01F 23/231; B01F 23/2375; B01F 35/221

(52) U.S. Cl. CPC B01F 23/231244; B01F 23/2375; B01F 35/2213; B01F 35/2217

(57) ABSTRACT

The present invention relates to a membrane-based system and process for generating nano- and pico-scale gas bubbles in a liquid phase with precise control over bubble size and gas-liquid ratio. The system comprises a porous substrate coated with a dense, non-porous, gas-permeable thin film that is preferably superhydrophobic when used with aqueous liquids. Gas is supplied to the porous side of the membrane, while a liquid flows along the dense film side under controlled shear conditions, causing the permeating gas to form nano- or pico-scale bubbles at the membrane-liquid interface. Bubble size and gas-liquid ratio are independently controlled by adjusting gas pressure, liquid flow rate, shear conditions, and temperature. The dense thin film may be polymeric or metallic. Polymeric films enable superhydrophobic, fouling-resistant membranes for efficient gas delivery, while metallic films, such as palladium, enable permeation of reactive gases at elevated temperatures. The coated membranes may be configured in high-surface-area modules, including hollow fiber modules. The invention enables enhanced gas-liquid mass transfer, improved reaction kinetics, and reduced energy consumption in chemical processing, catalysis, wastewater treatment, biological systems, and other industrial applications.

### FIELD OF THE INVENTION

The present invention relates to gas-liquid contacting technologies and, in particular, to a process and system for generating ultra-fine gas bubbles in a liquid phase, including nano bubbles having a size range of about 1 nm to 1000 nm, typically with an average diameter of about 200 nm, and pico bubbles having a size range of about 0.0001 nm to 1 nm, typically with an average diameter of about 0.6 nm, wherein bubble size distribution and volumetric gas-to-liquid ratio can be varied over a wide range from the nanobubble regime to the pico bubble regime, enabling enhanced gas dissolution, mass transfer, and controlled gas delivery for use in chemical, biological, environmental, energy, and industrial applications.

### BACKGROUND OF THE INVENTION

Nano- and pico-bubbles of a gas dispersed in a liquid are increasingly of interest due to their unique physical and chemical characteristics. These dispersions consist of gas bubbles of extremely small diameters, typically in the nanometer and sub-nanometer ranges, and exhibit behavior that differs fundamentally from that of larger bubbles such as microbubbles.

Nano- and pico-bubbles possess several distinctive properties. Due to the balance between buoyancy and gravitational forces, such bubbles exhibit extremely low-rise velocities in a liquid medium. In addition, nano- and pico-bubbles generally carry a negative surface charge resulting from the adsorption of hydroxyl ions from the surrounding liquid, which produces electrostatic repulsion between bubbles and inhibits coalescence into larger bubbles. Pico-bubbles, in particular, exhibit random motion driven by Brownian motion and are capable of moving throughout the liquid volume rather than rising to the surface.

The internal gas pressure within pico-bubbles is substantially higher than atmospheric pressure and increases as bubble diameter decreases. Both nano- and pico-bubbles deviate from Stokes' Law, which typically governs the motion of larger bodies and microbubbles in a fluid. Nanobubbles gradually shrink due to gas transfer from the bubble into the surrounding liquid and may eventually dissolve completely. During collapse or dissolution, nanobubbles may generate reactive species, such as hydroxyl radicals, which can oxidize materials present in the liquid. Pico-bubbles, by contrast, dissolve almost immediately, creating a supersaturated solution of the gas in the liquid phase.

Both nano- and pico-bubbles exhibit extremely high interfacial surface area between the gas and the surrounding liquid, enabling rapid mass transfer. For example, when air pico-bubbles are dispersed in water, the concentration of dissolved oxygen and nitrogen can exceed their normal solubility limits, resulting in a supersaturated condition. Pico-bubbles generally exhibit smaller size, higher mass transfer coefficients, higher negative zeta potential, greater stability, and negligible buoyancy compared to nanobubbles.

Despite these advantages, the generation of nano- and pico-bubbles in a controlled and scalable manner remains challenging. The published literature on pico-bubble generation is limited, with most prior work focused on nano- and microbubble production. Existing methods for generating nano- and pico-bubbles suffer from several significant drawbacks. First, bubble size is often not well controlled, resulting in broad size distributions rather than uniform bubble populations. Second, the achievable volumetric gas-to-liquid ratios are typically below five percent, which may be insufficient for applications requiring higher gas loading. Third, many conventional techniques are limited in efficiency, scalability, or operational reliability.

Various methods have been proposed for producing nano- and pico-bubbles. Membrane-based systems have been used in which gas is supplied through a permeable or porous membrane and sheared by liquid flow to form nanobubbles. In some configurations, a rotatable permeable member is employed, where turbulent shear at the membrane surface strips gas into the liquid phase. In other configurations, gas is supplied on one side of a porous membrane while liquid flows across the opposite surface, forming bubbles at membrane pores. These systems are sensitive to membrane pore size, surface chemistry, and operating conditions, and often face limitations related to fouling, durability, and scalability.

Friction-based methods have also been used to generate nanobubbles by forcing liquid through conduits with internal projections or by mechanically mixing gas and liquid using impellers. In such systems, frictional and shear forces break larger gas bubbles into smaller ones. However, control over bubble size, particularly in the pico-bubble range, remains difficult, and energy efficiency may be limited.

Additional approaches include releasing pressurized gas into a liquid, venturi-based gas-liquid mixing, and hydrodynamic cavitation. These methods rely on pressure reduction, intense mixing, or cavitation to nucleate and fragment gas bubbles. While capable of producing nanobubbles under certain conditions, these techniques often yield narrow operating windows, low optimal gas-liquid ratios, or inconsistent bubble sizes.

Electrolysis has also been used to generate gas bubbles when the liquid is water, with hydrogen and oxygen evolving at electrodes. However, electrochemical methods are constrained by electrode fouling, safety concerns associated with hydrogen generation, and limited control over bubble size, particularly for producing pico-bubbles.

Several patents and experimental systems have proposed devices for generating pico-bubbles using impellers, magnetic fields, venturi-based cavitation, or specialized flotation columns. While these approaches demonstrate the potential benefits of pico-bubbles in applications such as ozonated water production and mineral flotation, they often require complex equipment, operate at laboratory scale, or lack precise control over bubble size and gas concentration.

Accordingly, although nano- and pico-bubbles offer significant advantages due to their high surface area, enhanced gas dissolution, and stability in liquids, there remains a need for improved methods and systems capable of efficiently generating nano- and pico-bubbles with controlled size, higher gas-to-liquid ratios, and improved scalability for industrial and commercial applications.

### OBJECTS OF THE INVENTION

The primary objective of the present invention is to provide an improved method and system for generating nano- and pico-bubbles of a gas in a liquid phase that overcomes the limitations of existing technologies.

Another objective of the invention is to enable controlled generation of nano- and pico-bubbles with a narrow and selectable bubble size distribution, including the ability to preferentially generate pico-bubbles rather than nanobubbles.

Another objective of the invention is to increase the volumetric gas-to-liquid ratio of gas bubbles dispersed in the liquid, thereby providing a higher effective gas content than is achievable using conventional nano- and pico-bubble generation methods.

Another objective of the invention is to provide a highly efficient bubble generation process that enhances gas dissolution, mass transfer, and supersaturation of the liquid phase while minimizing energy consumption.

Another objective of the invention is to provide a scalable and robust nano- and pico-bubble generation system suitable for laboratory, pilot-scale, and industrial-scale applications.

Another objective of the invention is to generate nano- and pico-bubbles that exhibit high stability, strong negative surface charge, negligible buoyancy, and enhanced residence time within the liquid phase.

Another objective of the invention is to avoid or reduce the drawbacks associated with membrane fouling, electrode fouling, uncontrolled cavitation, and mechanical wear found in conventional nano- and pico-bubble generation techniques.

Another objective of the invention is to enable rapid and uniform dispersion of nano- and pico-bubbles throughout the liquid volume, including dispersion driven by Brownian motion in the case of pico-bubbles.

Another objective of the invention is to provide a bubble generation approach that facilitates rapid mass transfer of gas into the liquid, enabling the formation of supersaturated liquid solutions beyond equilibrium solubility limits.

Another objective of the invention is to provide a flexible system capable of operating with different gases and liquids, thereby making it suitable for a wide range of applications including water treatment, flotation, oxidation processes, gas dissolution, and chemical or biological processes.

Other objectives and advantages of the present invention will become apparent from the following detailed description when read in conjunction with the accompanying drawings.

### SUMMARY OF THE INVENTION

The present disclosure relates to a method for generating pico and nano bubbles of a gas in a liquid, comprising:
a) providing a porous surface coated on one side with a gas-permeable layer, wherein the gas-permeable layer is hydrophobic polymer;
b) introducing the gas on an uncoated side of the porous surface while flowing the liquid along the coated side of the porous surface;
c) providing shear forces that are generated by the flow of the liquid to release pico and nano bubbles of the gas from the surface of the gas-permeable layer, thereby forming a dispersion of pico and nano bubbles in the liquid.
The present disclosure also relates to a system for generating pico and nano bubbles of a gas in a liquid, comprising:
a porous substrate coated on one side with a gas-permeable layer;
a gas supply configured to introduce gas to an uncoated side of the porous substrate; and
a liquid flow passage configured to flow a liquid along the coated side of the porous substrate under shear conditions sufficient to release pico and nano bubbles into the liquid, and wherein the porous substrate and gas-permeable layer are configured as a hollow fiber membrane module.

### BRIEF DESCRIPTION OF THE DRAWINGS

The accompanying drawings are included to provide a further understanding of the present disclosure, and are incorporated in and constitute a part of this specification.

FIG. 1 illustrates a dense, gas-permeable, superhydrophobic, nanostructured film using a mixture of solvent, gas-permeable polymer and nanoparticles and spraying on a porous surface.

FIG. 2 illustrates examples of gas-permeable polymers that can be used for synthesizing nanostructured, superhydrophobic membranes.

FIG. 3 illustrates hollow fiber membrane module constructed using porous hollow fibers coated with the gas-permeable, superhydrophobic nanostructured membrane.

FIG. 4 illustrates nano and pico bubbles formed when gas permeates through the gas permeable,

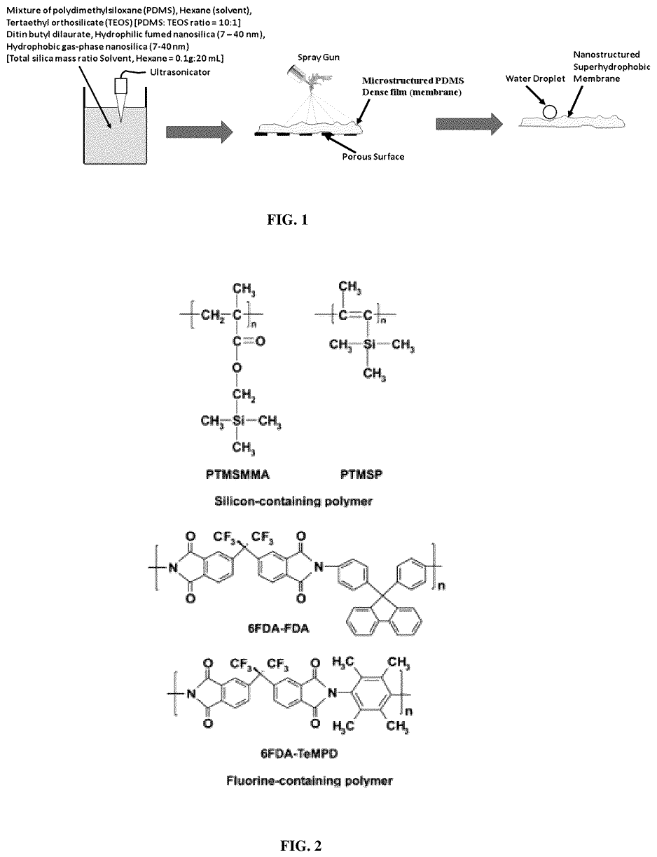

superhydrophobic, nanostructured membrane into a flowing liquid phase to create a liquid-nano and pico bubble mixture.

### DETAILED DESCRIPTION OF THE INVENTION

The following is a detailed description of embodiments of the disclosure. The embodiments are in such details as to clearly communicate the disclosure. However, the amount of detail offered is not intended to limit the anticipated variations of embodiments; on the contrary, the intention is to cover all modifications, equivalents, and alternatives falling within the scope of the present disclosures as defined by the appended claims.

The inventors of the present application have conceived a novel membrane-based technology for generating pico-scale and nano-scale gas bubbles within a liquid phase. While the technology is illustrated herein in the context of pico-bubble generation, it will be understood by those skilled in the art that the disclosed embodiments are illustrative in nature and that the technology may be implemented in alternative configurations, materials, and applications without departing from the scope of the invention or requiring undue experimentation.

The present invention provides a process and system for generating nano- and pico-scale gas bubbles in a liquid medium using a membrane-based gas-liquid contacting configuration. The system comprises a porous membrane substrate coated on one side with a dense, thin gas-permeable film. When the liquid medium is aqueous, the gas-permeable film is preferably hydrophobic so as to prevent liquid intrusion into the pores of the substrate while permitting controlled gas permeation.

In operation, gas is supplied to the porous side of the membrane substrate, while the liquid medium is caused to flow along the dense film side under high-shear conditions. The permeating gas interacts with the flowing liquid at the membrane-liquid interface, resulting in controlled nucleation and release of bulk nano- and pico-scale gas bubbles into the liquid phase. The membrane configuration enables the formation of bubbles significantly smaller than those produced by conventional sparging or bubbling techniques.

The size of the generated nano and pico bubbles, as well as the volumetric gas-to-liquid ratio, can be varied over a wide operational range by independently controlling gas pressure, gas flow rate, liquid pressure, liquid flow rate, and shear conditions along the membrane surface. Additional control over bubble characteristics may be achieved by selecting appropriate membrane properties, including pore size of the porous substrate, thickness of the dense gas-permeable film, and gas permeability of the film material.

In one implementation, the membrane is provided in the form of a hollow fiber module, wherein each hollow fiber comprises a porous substrate coated with a gas-permeable hydrophobic polymer film suitable for aqueous liquid systems. Gas is supplied to the porous region of the hollow fibers, while the liquid medium flows along the outer surface of the coated fibers. This configuration enables uniform gas permeation and stable generation of nano and pico bubbles within the flowing liquid.

In another implementation, the porous substrate is coated with a metallic film, such as palladium or a palladium-based alloy, particularly suited for high-temperature operation or for gases capable of dissociative permeation through metal membranes. When such metallic membranes are used, permeating gases, for example hydrogen, are delivered into the liquid phase in a highly reactive state. The combination of the activated gas species and pico-scale bubble dimensions results in substantially enhanced gas-liquid reaction kinetics compared to conventional gas bubbling methods.

The process is applicable to a wide range of gases, including hydrogen, oxygen, nitrogen, carbon dioxide, air, or mixtures thereof, and to various liquid media, including water, aqueous solutions, organic solvents, or combinations thereof. The membrane-based system is scalable through modular assembly of multiple membrane units and is suitable for applications requiring enhanced gas-liquid mass transfer, including chemical processing, pharmaceutical manufacturing, catalytic reactions, energy-related processes, wastewater treatment, biomedical applications, and advanced material synthesis.

In an embodiment, porosity is defined as the ratio of void volume to total volume, and is typically measured via gravimetric (liquid uptake) methods, mercury intrusion porosimetry, or scanning electron microscopy (SEM) analysis. Typical values range from 30% to 80% for many polymeric membranes, while ceramic membranes often have porosities between 40% and 60%. The porosity can be measured using well-known methods.

In one embodiment, a porous membrane substrate is coated with a dense, non-porous, gas-permeable thin film that is superhydrophobic when used with aqueous liquids. The porous substrate may comprise an ultrafiltration membrane formed from polymeric, metallic, ceramic, or composite materials. The dense thin film acts as a selective gas-permeation layer while preventing penetration of the liquid phase into the pores of the substrate. To achieve high membrane surface area within a compact volume, the membrane may be configured as hollow fibers, although tubular, spiral-wound, flat-sheet, or other membrane module geometries may also be employed.

The superhydrophobic thin film is formed by creating a micro- or nano-structured rough surface in combination with a low-surface-energy material. Such surfaces are inspired by naturally occurring superhydrophobic phenomena, including the lotus effect. The thin film may be formed from any gas-permeable polymer capable of being structured to exhibit superhydrophobicity. In one implementation, a polymer such as polydimethylsiloxane is used due to its high gas permeability and hydrophobic character. Nanoparticles may be incorporated into the polymer matrix to create the required surface roughness and enhance superhydrophobic behavior.

In an experimental embodiment, a superhydrophobic gas-permeable film is prepared by dissolving polydimethylsiloxane in a volatile solvent and incorporating a silica precursor and nanosilica particles to generate a micro-textured surface upon coating. The resulting coating exhibits a water contact angle of at least 150 degrees, demonstrating superhydrophobic behavior. The film is mechanically robust, resistant to fouling, and capable of withstanding high liquid shear forces during operation. It is noted that the contact angle can be measured by taking a photograph of a single drop of the liquid on the surface using a portable phone, or other methods such as a Wilhelmy plate.

The invention is not limited to polydimethylsiloxane as the coating polymer. Other hydrophobic polymers with high gas permeability may be used, including perfluorinated polymers, substituted polyacetylenes, addition-type polynorbornenes, polymers of intrinsic microporosity, poly(trimethylsilyl propyne), poly(vinyl chloride), and selected polyimides. High-permeability membranes may also be produced by thermal rearrangement of suitable precursor polymers. The selected polymer preferably exhibits a low affinity for water while allowing rapid diffusion of gases through the polymer matrix.

The gas-permeable, superhydrophobic thin film may be deposited onto the porous substrate using a variety of coating techniques. These techniques include dip coating, spin coating, spray coating, infiltration coating, and layer-by-layer assembly. Dip coating involves immersing the porous substrate into a diluted polymer solution followed by controlled withdrawal and curing, enabling scalable production of thin coatings. Spin coating may be used for flat or slightly curved membranes to produce ultra-thin, uniform films with minimal pore blockage. Spray coating is particularly suitable for porous or irregular surfaces and allows control of coating thickness through multiple passes. Infiltration coating may be employed to selectively modify surface pores while maintaining overall porosity, and layer-by-layer assembly may be used where molecular-level control of film thickness is required.

In another embodiment, the dense thin film is metallic rather than polymeric. Certain metals exhibit gas permeability at elevated temperatures, enabling selective gas transport through the metal lattice. Palladium and palladium-based alloys are particularly suitable for hydrogen permeation. The metallic film may be deposited onto a porous substrate using electroless deposition, electroplating, physical vapor deposition, chemical vapor deposition, atomic layer deposition, solution-based impregnation and reduction, or electrophoretic deposition. These methods allow formation of uniform metallic films with thickness in the micron or sub-micron range while preserving the porosity and mechanical integrity of the underlying substrate.

In an embodiment, shear condition to introduce gas means gas can be introduced at pressures needed to allow the gas to be transported across the membrane, and temperatures that the membrane can withstand without deterioration. Further, shear force exerted by the liquid depends on the flow velocity of the liquid, used in the process. Also, shear force must exceed the surface tension forces, causing the gas bubble to adhere to the surface of the membrane.

In an embodiment, the porous surface is selected from the group consisting of a polymeric, metallic, ceramic, or composite or porous material. Examples of polymeric includes polypropylene, polyvinyl chloride, etc. Examples of ceramic includes alumina, porous metals, etc. Metallic surface includes aluminum, stainless steel, etc.

The coated membrane may be assembled into a high-surface-area membrane module. In one embodiment, the module is a hollow-fiber membrane module comprising porous hollow fibers coated on their outer surface with the dense gas-permeable film. Pressurized gas is supplied to the interior of the hollow fibers, while the liquid phase flows along the exterior surface of the fibers. Gas permeates through the dense film and appears as pico-scale or nano-scale bubbles at the membrane-liquid interface. The flowing liquid applies a shear force that removes the bubbles from the membrane surface, forming a mixture of liquid and pico or nano bubbles that exits the module. Gas pressure within the fibers is maintained by regulating inlet and outlet valves to ensure steady-state permeation conditions.

A significant advantage of this membrane-based pico-bubble generation method is the ability to independently control gas and liquid operating parameters. Gas pressure, gas flow rate, liquid flow rate, liquid shear, and temperature may be adjusted independently to control bubble size distribution and gas-to-liquid volumetric ratio. Increasing temperature may further enhance gas permeation through the dense film. Due to the superhydrophobic nature of the membrane surface, minimal liquid shear is required to detach pico bubbles from the membrane, enabling high gas-liquid ratios even at relatively low liquid flow rates.

When the dense membrane is metallic, such as palladium, hydrogen permeates through the metal film at elevated temperatures and emerges at the membrane surface in a highly reactive state. Pico- or nano-scale hydrogen bubbles formed at the membrane interface rapidly interact with a liquid, such as oil, flowing along the membrane surface. This configuration enables hydrogenation reactions to proceed at significantly higher reaction rates compared to conventional hydrogen bubbling techniques, due to enhanced gas-liquid mass transfer and increased reactivity of the permeated hydrogen.

When the dense membrane is polymeric and permeable to oxygen, an alternative embodiment enables biological applications. Biofilms may be immobilized on the dense, nanostructured polymeric membrane surface. Oxygen permeates continuously through the membrane and is delivered directly to the biofilm at the membrane-biofilm interface. This enables formation of robust biofilms and efficient biological treatment of wastewater in a membrane bioreactor system. Such a system significantly reduces energy consumption compared to conventional aerated biofilm reactors and allows the use of pure oxygen rather than air, as oxygen is delivered directly to the biofilm without loss to the bulk liquid phase.

The described embodiments demonstrate that the disclosed membrane technology provides a versatile and energy-efficient platform for controlled pico- and nano-bubble generation and gas delivery across a wide range of chemical, biological, and industrial processes.

The invention is further illustrated by the following examples, which is provided to be exemplary of the invention and does not limit the scope of the invention. While the present disclosure has been described in terms of its specific embodiments, certain modifications and equivalents will be apparent to those skilled in the art and are intended within the scope of the present invention.

### EXAMPLES

### Example 1: Preparation of Membrane for Generating Nano and Pico Bubbles Using a Dip Coating Process

A dip-coating process is used for forming a gas-permeable, hydrophobic thin film on a porous membrane. The process includes preparing a polymer solution by mixing polydimethylsiloxane (PDMS) with a solvent such as hexane or toluene to reduce viscosity and obtain a uniform coating solution, typically using a polymer-to-solvent ratio of 1:10.

The porous membrane is then dipped into the polymer solution for a short, controlled period of time, such as a few seconds to a few minutes, allowing the polymer solution to coat the surface of the membrane. The membrane is subsequently withdrawn slowly from the solution so that excess polymer drains off, resulting in a substantially uniform thin film covering the membrane surface.

After coating, the membrane is cured by heating at a temperature in the range of about 60° C. to about 120° C. for a period of about 1 to 4 hours to crosslink the polymer and form a dense, gas-permeable, hydrophobic coating. The coated membrane obtained by this process is suitable for use in generating nano- and pico-scale gas bubbles in a liquid phase.

### Example 2: Preparation of Flat Membrane for Generating Nano and Pico Bubbles Using a Spray Coating Process

A spray-coating process is used for forming a thin, gas-permeable polymer layer on a porous membrane. The process includes preparing a sprayable polymer solution by diluting polydimethylsiloxane (PDMS) or another suitable polymer with hexane or any other compatible solvent in a ratio of 1:10 to obtain a low-viscosity solution.

The coating is applied by adjusting spray parameters using an airbrush, ultrasonic sprayer, or similar spraying device equipped with a fine nozzle to achieve uniform atomization. The polymer solution is sprayed onto the surface of the membrane in multiple thin passes, allowing partial evaporation of the solvent between successive passes to avoid pore blockage and ensure uniform film formation.

After completing the spraying step, the coated membrane is cured by heating at a temperature in the range of about 60° C. to about 120° C. for a sufficient duration to crosslink the polymer and stabilize the coating. The spray-coated membrane obtained by this process is suitable for applications involving controlled gas transfer and nano-or pico-bubble generation.

### Example 3: Constructing a High Surface Area Membrane Module

A coated membrane is being used to construct a high-surface-area membrane module. The module is being assembled as a hollow-fiber membrane module using coated polypropylene hollow fibers. The hollow fibers are being coated on an outer surface, thereby forming a gas-permeable membrane layer on the porous hollow fibers.

The coated hollow fibers are being potted and assembled into a standard hollow-fiber module configuration, wherein a gas phase is being supplied to an interior of the hollow fibers while a liquid phase is being pumped through a shell side surrounding the hollow fibers. The gas is being maintained under pressure within the hollow fibers.

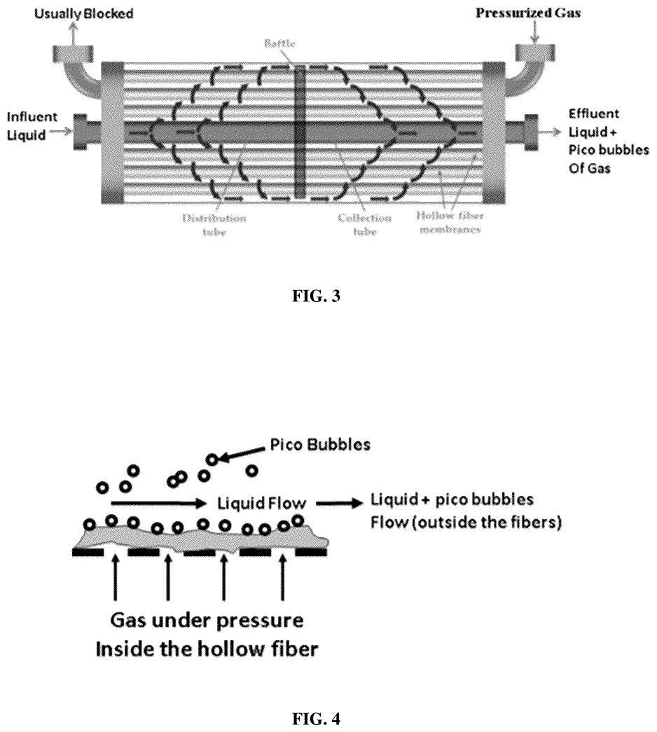

During operation, the gas is permeating from the inside of the hollow fibers through the coated membrane layer and appearing as pico bubbles on the outer surface of the membrane. The flowing liquid phase is generating shear forces, thereby facilitating detaching and dispersing the pico bubbles from the membrane surface into the liquid phase. The resulting mixture of liquid and pico bubbles is exiting the membrane module as an outlet stream. (Please refer to FIGS. 3 and 4).

Gas pressure within the hollow fibers is being regulated by closing an exit gas valve and introducing additional gas as required to maintain a substantially uniform gas pressure inside the hollow fibers during operation.

### Example 4: Depositing Superhydrophobic Films on a Variety of Porous Surfaces

Experiments were conducted in depositing superhydrophobic films on a variety of porous surfaces using spray coating a mixture of PDMS and SiO₂ nanoparticles. This created a textured surface (FIG. 1) that was superhydrophobic and gas permeable since PDMS exhibits gas permeation characteristics.

Initially, 1 g of PDMS was dissolved in 20 mL of n-Hexane (solvent). Tetraethyl orthosilicate (TEOS) was added such that the PDMS: TEOS mass ratio was 10:1. Ditin butyl dilaurate (0.1 g) was also added to this mixture and mixed using an ultra sonicator. 0.1 g of an equal amount by mass mixture of hydrophilic fumed nanosilica (7-40 nm) and hydrophobic gas-phase nanosilica (7-40 nm) were also mixed and ultrasonically mixed for 15 minutes. This mixture was spray coated on a porous glass surface at a spray pressure of 5 psi for one cycle only to achieve a thin dense film. The coated film was dried for 1 hour at room temperature to obtain a gas permeable, superhydrophobic film. FIG. 1 shows the process used to synthesize the dense film (membrane). The coating has a contact angle for water droplets of at least 150°. The coated film is very durable and can last a high liquid shear environment and cannot be easily fouled.

In an embodiment of the present disclosure, dense film means no pores in film. Further, the thickness is usually 1-10 microns, measured by well-known standard methods.

### Specific Embodiments of the Present Disclosure

The present disclosure relates to a method for generating pico and nano bubbles of a gas in a liquid, comprising:
d) providing a porous surface coated on one side with a gas-permeable layer, wherein the gas-permeable layer is hydrophobic polymer;
e) introducing the gas on an uncoated side of the porous surface while flowing the liquid along the coated side of the porous surface;
f) providing shear forces that are generated by the flow of the liquid to release pico and nano bubbles of the gas from the surface of the gas-permeable layer, thereby forming a dispersion of pico and nano bubbles in the liquid.
Such method is disclosed, wherein the porous surface comprises a microfiltration, ultrafiltration, or nanofiltration membrane.
Such method is disclosed, wherein the porous surface is selected from a polymeric, metallic, ceramic, or composite porous material.
Such method is disclosed, wherein the hydrophobic polymer is selected from polydimethylsiloxane, perfluorinated polymers, substituted polyacetylenes, poly(trimethylsilyl propyne), polymers of intrinsic microporosity, poly(vinyl chloride), polyimides, or combinations thereof.
Such method is disclosed, wherein the gas-permeable layer comprises a metallic film selected from palladium or palladium-based alloys.
Such method is disclosed, wherein bubble size and gas-liquid ratio are controlled by independently adjusting gas pressure, gas flow rate, liquid flow rate, liquid shear rate, or temperature.
Such method is disclosed, wherein the gas is selected from hydrogen, oxygen, nitrogen, carbon dioxide, air, or mixtures thereof.
Such method is disclosed, wherein the liquid comprises water, an aqueous solution, an organic liquid, oil, or mixtures thereof.
Such method is disclosed, wherein the porous surface coated with the gas-permeable layer is configured as a hollow fiber membrane.
The present disclosure also relates to a system for generating pico and nano bubbles of a gas in a liquid, comprising:
a porous substrate coated on one side with a gas-permeable layer;
a gas supply configured to introduce gas to an uncoated side of the porous substrate; and
a liquid flow passage configured to flow a liquid along the coated side of the porous substrate under shear conditions sufficient to release pico and nano bubbles into the liquid, and wherein the porous substrate and gas-permeable layer are configured as a hollow fiber membrane module.
Such system is disclosed, wherein the gas-permeable layer is hydrophobic polymer.
Such system is disclosed, wherein the gas-permeable layer comprises a metallic film for gas permeation at elevated temperatures. The elevated temperature means any temperature above ambient temperature. The ambient temperature can be typically between 20 to 30 degree Celsius.

Such system is disclosed, wherein the gas is supplied to an interior of hollow fibers and the liquid flows along an exterior surface of the hollow fibers.

Such system is disclosed, further comprising a control unit configured to independently regulate gas pressure and liquid flow rate.

Such system is disclosed, wherein the gas-permeable layer has a water contact angle of at least 150-180 degrees.

### Industrial Applicability

The membrane-based system and process disclosed in the present invention are industrially applicable across a wide range of sectors requiring efficient gas-liquid contacting, enhanced mass transfer, and precise control over gas delivery at nano- and pico-scale dimensions.

In water and wastewater treatment applications, the ability to generate pico and nano bubbles enables highly efficient dissolution of gases such as oxygen and ozone. Pico bubbles, due to their extremely small size and rapid dissolution, are particularly effective for advanced oxidation processes, rapid oxygenation, and degradation of recalcitrant pollutants. Nanobubbles, owing to their longer stability, are suitable for sustained aeration and continuous treatment processes in water treatment plants.

In biomedical and healthcare applications, the disclosed technology enables controlled generation of ultra-fine gas bubbles capable of interacting at cellular and molecular scales. Pico bubbles may be used for enhanced drug and gene delivery, improved tissue oxygenation, and advanced therapeutic applications where penetration of biological barriers is required. Nanobubbles are applicable in medical imaging, ultrasound contrast enhancement, wound healing, and oxygen delivery systems.

In industrial cleaning processes, including semiconductor manufacturing and medical instrument sterilization, pico bubbles can penetrate nano-sized surface pores and microstructures, enabling effective removal of contaminants, residues, and biofilms. Nanobubbles provide sustained cleaning action and are suitable for applications requiring prolonged interaction with surfaces.

In food and beverage processing, the invention enables efficient gas infusion into liquids and emulsions. Pico bubbles improve gas dissolution and distribution, enhancing texture, stability, and sensory properties of beverages and food products. Nanobubbles may be used for controlled infusion of oxygen or carbon dioxide to improve freshness, shelf life, and taste.

In agriculture and aquaculture, the disclosed system supports rapid and efficient delivery of oxygen and nutrients. Pico bubbles facilitate cellular-level oxygenation, improving plant metabolism and fish health, while nanobubbles provide sustained aeration in hydroponic systems, aquaculture tanks, and irrigation water.

In oil and gas recovery operations, pico bubbles can enhance oil displacement and extraction efficiency at microscopic pore levels by improving gas penetration, altering interfacial properties, and enhancing mass transfer. Nanobubbles are applicable in enhanced oil recovery processes involving wettability modification and viscosity reduction.

In catalysis and chemical processing, the invention enables higher reaction rates due to enhanced gas-liquid mass transfer and increased interfacial surface energy. Pico bubbles are particularly advantageous for rapid reactions such as hydrogenation, oxidation, and reduction processes, while nanobubbles support sustained catalytic activity.

In electronics, nanotechnology, and advanced manufacturing, the technology supports precision cleaning, microfabrication, and nanoparticle synthesis. Pico bubbles enable removal of contaminants at extremely small scales, while nanobubbles facilitate controlled reaction environments.

In energy-related applications, including batteries and fuel cells, pico and nano bubbles may enhance electrochemical reactions, improve charge transfer efficiency, reduce electrode fouling, and improve overall system performance.

### Technical Advantages

The present invention provides several technical advantages over conventional gas bubbling and porous membrane aeration systems.

A primary advantage lies in the ability to generate pico- and nano-scale gas bubbles, measured by bubble movement and light scattering method, with precise control over bubble size and gas-liquid ratio. Pico bubbles dissolve almost instantaneously due to their extremely small size and high surface energy, making them ideal for applications requiring rapid gas infusion and fast reaction kinetics. Nanobubbles, in contrast, exhibit high stability and persistence, enabling sustained gas delivery over extended periods.

The invention enables independent control of gas pressure, liquid flow rate, shear force, and temperature, allowing flexible operation across diverse applications. This independent tunability is not achievable with conventional sparging or porous membrane systems.

The use of dense, non-porous, gas-permeable membranes prevents liquid intrusion and bubble coalescence, resulting in higher gas utilization efficiency and reduced energy consumption. Superhydrophobic polymeric membranes further reduce fouling and allow bubble release at minimal shear forces, enabling high gas-liquid ratios even at low liquid flow rates. It is to be noted that the gas utilization efficiency increases with decreasing bubble diameter and this is a known fact to people working in this field. Reduced energy is mainly due to higher gas utilization that results in needing less gas flow.

Metallic dense membranes, such as palladium, provide an additional technical advantage by enabling permeation of gases in a reactive or activated state. This significantly enhances reaction rates in gas-liquid chemical processes, particularly hydrogenation reactions, compared to conventional gas bubbling techniques.

The membrane-based configuration offers high surface-area-to-volume ratios and modular scalability, making the system suitable for both laboratory-scale and industrial-scale deployment. The technology also enables direct gas delivery to interfaces, such as biofilms or catalytic surfaces, minimizing gas loss and improving process efficiency.

Overall, the invention provides a versatile, energy-efficient, and highly controllable platform for gas-liquid interactions, enabling applications that are not feasible or are inefficient using existing nano-or micro-bubble generation technologies.

1. A method for generating pico and nano bubbles of a gas in a liquid, comprising:
a) providing a porous surface coated on one side with a gas-permeable layer, wherein the gas-permeable layer is hydrophobic polymer;
b) introducing the gas on an uncoated side of the porous surface while flowing the liquid along the coated side of the porous surface;
c) providing shear forces that are generated by the flow of the liquid to release pico and nano bubbles of the gas from the surface of the gas-permeable layer, thereby forming a dispersion of pico and nano bubbles in the liquid.

2. The method of claim 1, wherein the porous surface comprises a microfiltration, ultrafiltration, or nanofiltration membrane.

3. The method of claim 1, wherein the porous surface is selected from a polymeric, metallic, ceramic, or composite porous material.

4. The method of claim 1, wherein the hydrophobic polymer is selected from polydimethylsiloxane, perfluorinated polymers, substituted polyacetylenes, poly(trimethylsilyl propyne), polymers of intrinsic microporosity, poly(vinyl chloride), polyimides, or combinations thereof.

5. The method of claim 1, wherein the gas-permeable layer comprises a metallic film selected from palladium or palladium-based alloys.

6. The method of claim 1, wherein the gas is selected from hydrogen, oxygen, nitrogen, carbon dioxide, air, or mixtures thereof.

7. The method of claim 1, wherein the liquid comprises water, an aqueous solution, an organic liquid, oil, or mixtures thereof.

8. The method of claim 1, wherein the porous surface coated with the gas-permeable layer is configured as a hollow fiber membrane.

9. A system for generating pico and nano bubbles of a gas in a liquid, comprising:
a porous substrate coated on one side with a gas-permeable layer;
a gas supply configured to introduce gas to an uncoated side of the porous substrate; and
a liquid flow passage configured to flow a liquid along the coated side of the porous substrate under shear conditions sufficient to release pico and nano bubbles into the liquid, and wherein the porous substrate and gas-permeable layer are configured as a hollow fiber membrane module.

10. The system of claim 9, wherein the gas-permeable layer is hydrophobic polymer.

11. The system of claim 9, wherein the gas-permeable layer comprises a metallic film for gas permeation at elevated temperatures.

12. The system of claim 9, wherein the gas is supplied to an interior of hollow fibers and the liquid flows along an exterior surface of the hollow fibers.

13. The system of claim 9, further comprising a control unit configured to independently regulate gas pressure and liquid flow rate.

14. The system of claim 9, wherein the gas-permeable layer has a water contact angle of at least 150-180 degrees.
